(19) United States
(12) Patent Application Publication
(10) Pub. No.: US 2007/0175247 A1
(43) Pub. Date: Aug. 2, 2007

(54) Double lock having indication function

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/396,696

(22) Filed: Apr. 4, 2006

(30) Foreign Application Priority Data
Jan. 27, 2006 (TW) 095103653

(51) Int. Cl. E05B 73/00

(52) U.S. Cl. 70/58

(57) ABSTRACT

A double lock includes a first lock body including a key lock mechanism, a second lock body movably mounted on the first lock body and including a number lock mechanism, and an indicator movably mounted on the second lock body. The second lock body is lockable and unlockable by either one of the key lock mechanism and the number lock mechanism. When the number lock mechanism misses a correct code, the indicator is driven by the second lock body to an indication position, and when the number lock mechanism reaches the correct code, the indicator is driven by the second lock body to return to an original position. Thus, the double lock has an indication function without having to provide a shackle that is used in the conventional padlock.

### BACKGROUND OF THE INVENTION

1. Field of the Invention

The present invention relates to a double lock, and more particularly to a double lock having an indication function.

2. Description of the Related Art

A conventional double lock in accordance with the prior art disclosed in the U.S. Patent Publication No. 2005/0155397 is available for a luggage binding strap which is used to bind a luggage.

A conventional padlock in accordance with the prior art disclosed in the U.S. Pat. No. 6,877,345 comprises a housing, a shackle, a number lock module, a key lock module, and an indicator. The shackle is movably mounted on the housing. The housing has a window for exposing the indicator which presents a first color in the window. When the key lock module is unlocked, the indicator presents a second color in the window so as to remind the user that the key lock module has been unlocked. When the number lock module is unlocked, the indicator is reset to present the first color in the window. However, the conventional padlock needs to provide a shackle.

### SUMMARY OF THE INVENTION

The primary objective of the present invention is to provide a double lock having an indication function.

Another objective of the present invention is to provide a double lock, wherein the double lock has an indication function to remind the user if the double lock has been unlocked by the specific key held by an inspector of the customs for checking the luggage.

A further objective of the present invention is to provide a double lock, wherein the double lock has an indication function without having to provide a shackle that is used in the conventional padlock, thereby enhancing the versatility of the double lock.

In accordance with one embodiment of the present invention, there is provided a double lock, comprising:

a first lock body including a key lock mechanism;

a second lock body pivotally mounted on the first lock body and including a number lock mechanism, wherein the second lock body is lockable by the key lock mechanism and the number lock mechanism and is unlockable by either one of the key lock mechanism and the number lock mechanism; and

an indicator mounted on the second lock body, wherein when the number lock mechanism misses a correct code, the indicator is driven by the second lock body to an indication position, and when the number lock mechanism reaches the correct code, the indicator is driven by the second lock body to return to an original position.

In accordance with another embodiment of the present invention, there is provided a double lock, comprising:

a first lock body including a first housing, and a key lock mechanism mounted on the first housing;

a second lock body including a second housing pivotally mounted on the first housing, and a number lock mechanism mounted on the second housing, wherein the second housing is lockable by the key lock mechanism and the number lock mechanism and is unlockable by either one of the key lock mechanism and the number lock mechanism; and

an indicator mounted on the second lock body, wherein when the number lock mechanism misses a correct code, the indicator is driven by the second lock body to an indication position, and when the number lock mechanism reaches the correct code, the indicator is driven by the second lock body to return to an original position.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a double lock in accordance with the preferred embodiment of the present invention;

FIG. 2 is a perspective view of a second lock body of the double lock as shown in FIG. 1;

FIG. 3 is a perspective assembly view of the double lock as shown in FIG. 1;

FIG. 4 is a plan cross-sectional view of the double lock as shown in FIG. 3;

FIG. 5 is a locally enlarged plan cross-sectional view of the double lock as shown in FIG. 1;

FIG. 6 is a locally enlarged top plan view of the double lock as shown in FIG. 1;

FIG. 7 is a schematic operational view of the double lock as shown in FIG. 3;

FIG. 8 is a schematic operational view of the double lock as shown in FIG. 4;.

FIG. 9 is a schematic operational view of the double lock as shown in FIG. 6;

FIG. 10 is a schematic operational view of the double lock as shown in FIG. 4;

FIG. 11 is a schematic operational view of the double lock as shown in FIG. 5;

FIG. 12 is a schematic operational view of the double lock as shown in FIG. 6; and

FIG. 13 is a schematic operational view of the double lock as shown in FIG. 12.

### DETAILED DESCRIPTION OF THE INVENTION

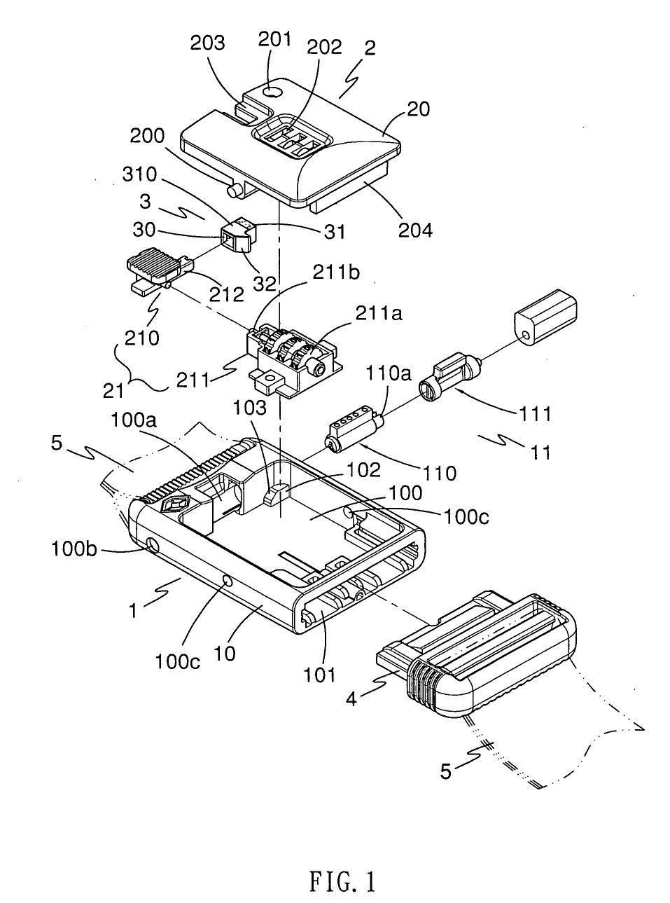

Referring to the drawings and initially to FIG. 1, a double lock is available for a luggage binding strap 5. The luggage binding strap 5 is used to bind a luggage (not shown) and has a first end attached to an insert 4 and a second end attached to the double lock.

The double lock in accordance with the preferred embodiment of the present invention comprises a first lock body 1, a second lock body 2, and an indicator 3.

The first lock body 1 includes a first housing 10, and a key lock mechanism 11 mounted on the first housing 10. The first housing 10 is formed with a receiving recess 100, a breach 100a communicating with the receiving recess 100, an elongated hole 100b communicating with the breach 100a, two opposite shaft holes 100c each communicating with the receiving recess 100, a slot 101 communicating with the receiving recess 100 and located opposite to the breach 100a to allow insertion of the insert 4, and a push block 102 located at a corner between the receiving recess 100 and the breach 100a. The push block 102 has a first ramp 103. The key lock mechanism 11 includes a lock core 110 secured in the elongated hole 100b, and a catch block 111 rotatably mounted in the breach 100a. The lock core 110 has a spindle 110a engaged with the catch block 111. The spindle 110a can be rotated by a specific key (not shown) matching the lock core 110.

The second lock body 2 includes a second housing 20 movably mounted in the receiving recess 100 of the first housing 10, and a number lock mechanism 21 mounted on the second housing 20. More specifically, the second housing 20 has two sides each having a middle portion provided with a shaft 200 pivotally mounted in the respective shaft hole 100c of the first housing 10, so that the second housing 20 is pivotally mounted in the receiving recess 100 of the first housing 10. The second housing 20 has a peep hole 201 aligning with the push block 102 of the first housing 10, a plurality of mounting slots 202 arranged in a serial manner, a slideway 203 aligning with the breach 100a of the first housing 10, and a locking block 204 aligning with the slot 101 of the first housing 10. The number lock mechanism 21 includes a push button 210, and a number wheel unit 211. The push button 210 is slidably mounted in the slideway 203 of the second housing 20 and has a bottom provided with a guide lever 212 located under the peep hole 201 of the second housing 20. The number wheel unit 211 is mounted on the second housing 20 and includes a plurality of number wheels 211a rotatably mounted in the mounting slots 202 of the second housing 20, and a movable shaft 211b connected to the push button 210.

In operation, the movable shaft 211b is movable axially when the number wheels 211a are rotated to reach a correct code of the number wheel unit 211, and is fixed and not movable axially when the number wheels 211a are rotated to miss the correct code of the number wheel unit 211.

The indicator 3 has a bottom face facing the push block 102 of the first housing 10 and a top face having a first portion formed with a first identification zone 31 and a second portion formed with a second identification zone 310. Preferably, the first identification zone 31 of the indicator 3 has a red color, and the second identification zone 310 of the indicator 3 has a green color. The indicator 3 has an inside formed with a mounting hole 30 mounted on the guide lever 212 of the push button 210 so that the indicator 3 is slidable on the guide lever 212 of the push button 210. The indicator 3 has a side formed with a second ramp 32.

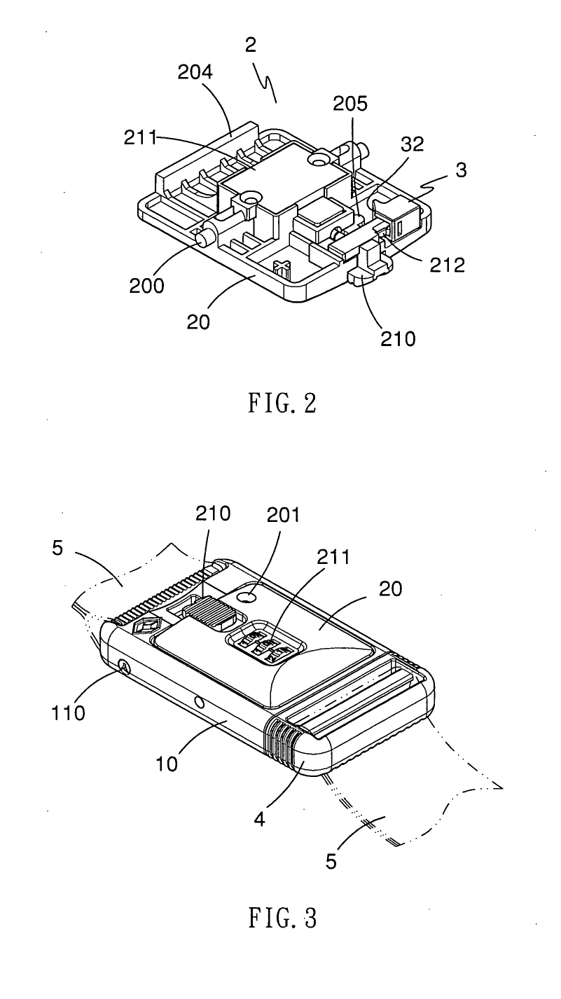

Referring to FIG. 2, the second housing 20 has a bottom provided with a guide block 205 facing the second ramp 32 of the indicator 3.

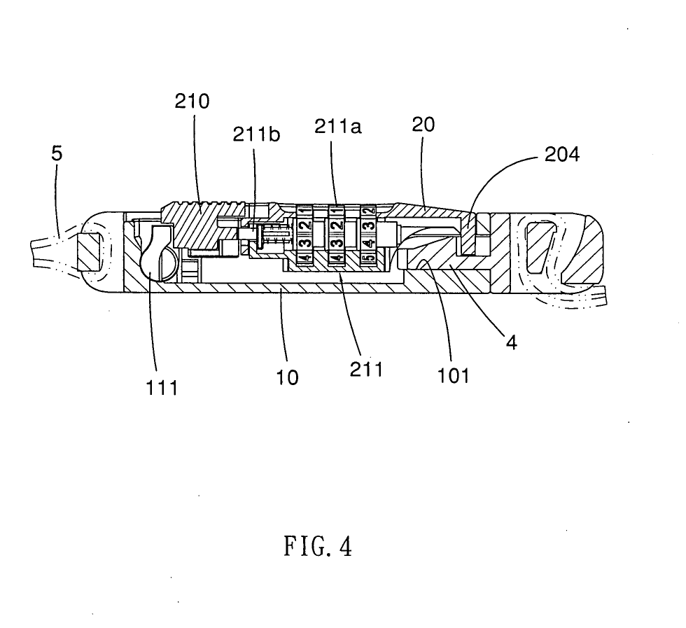

Referring to FIGS. 3 and 4, the insert 4 is inserted into the slot 101 of the first housing 10 and is locked by the locking block 204 of the second housing 20. At this time, the number wheels 211a of the number wheel unit 211 are rotated to miss the correct code of the number wheel unit 211 so that the movable shaft 211b is fixed and not movable axially. At the same time, the spindle 110a of the lock core 110 is not rotated by the specific key so that the catch block 111 is located at the original position to stop the push button 210 so that the second housing 20 is fixed and cannot be pivoted. Thus, the insert 4 is locked by the locking block 204 of the second housing 20 and cannot be detached from the slot 101 of the first housing 10. In such a manner, the second lock body 2 is locked by the key lock mechanism 11 and the number lock mechanism 21, so that the double lock is disposed at a locked state to lock the insert 4 so as to lock the luggage binding strap 5.

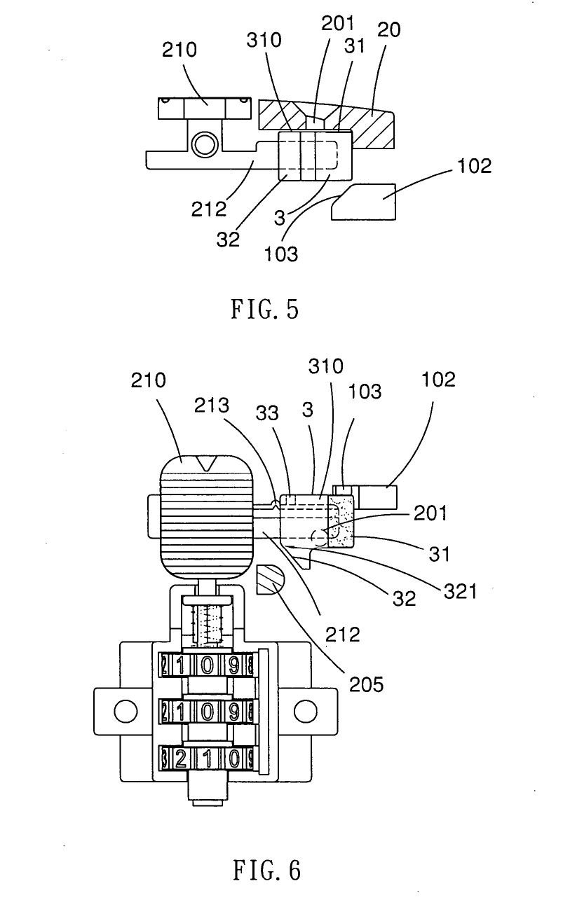

Referring to FIGS. 5 and 6, the indicator 3 and the push button 210 are located at the original position, the peep hole 201 of the second housing 20 is aligning with the second identification zone 310 of the indicator 3 to present the green color, the first ramp 103 of the push block 102 faces the bottom face of the tail portion of the indicator 3, and the second ramp 32 of the indicator 3 has a first side 321 facing the guide block 205 of the second housing 20. Thus, when the double lock is disposed at a locked state as shown in FIG. 4, the indicator 3 is located at the original position, and the peep hole 201 of the second housing 20 presents the green color.

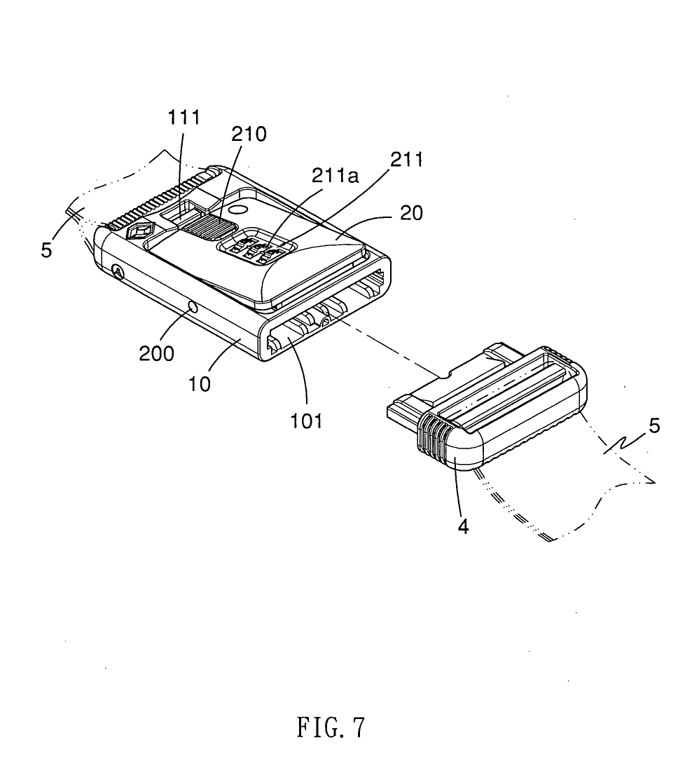

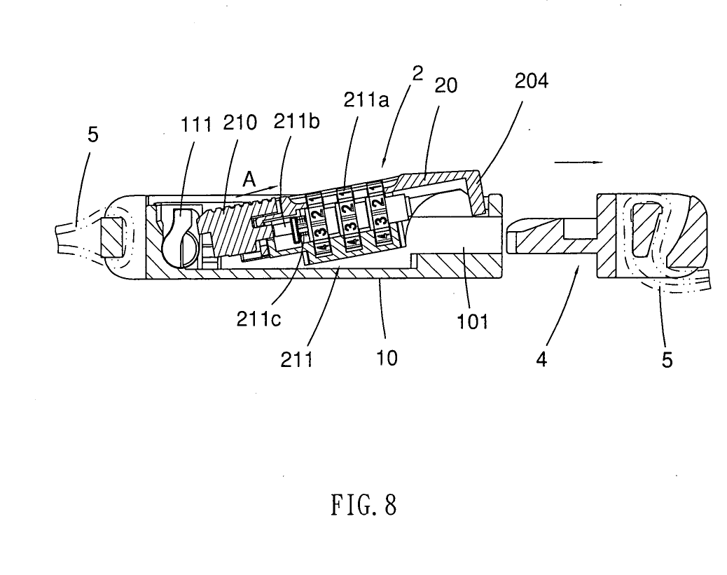

Referring to FIGS. 7 and 8, the number wheels 211a of the number wheel unit 211 are rotated to reach a correct code of the number wheel unit 211, so that the movable shaft 211b is movable axially. At this time, when the push button 210 is pushed in the direction indicated by the arrow “A”, the push button 210 is pushed to detach from the catch block 111, to push the movable shaft 211b and to compress a spring 211c mounted on the movable shaft 211b. Then, the push button 210 is pressed downward, so that the second housing 20 is pivoted about the shafts 200 to move the locking block 204 upward to release the insert 4 from the locking block 204, thereby removing the insert 4 from the slot 101 of the first housing 10 as shown in FIG. 8. Thus, the second lock body 2 is released by the number lock mechanism 21, so that the double lock is disposed at a first unlocked state. When the double lock is disposed at the first unlocked state, the insert 4 is removed from the slot 101 of the first housing 10 to release the luggage binding strap 5. At this time, the spindle 110a of the lock core 110 is not rotated by the specific key to drive the catch block 111 to leave the push button 210. When the force applied on the push button 210 is removed, the movable shaft 211b is pushed and returned to the original state by the restoring force of the spring 211c to push the push button 210 to the original state. At the same time, the second housing 20 is also pushed and returned to the original state by the restoring force of a second spring (not shown).

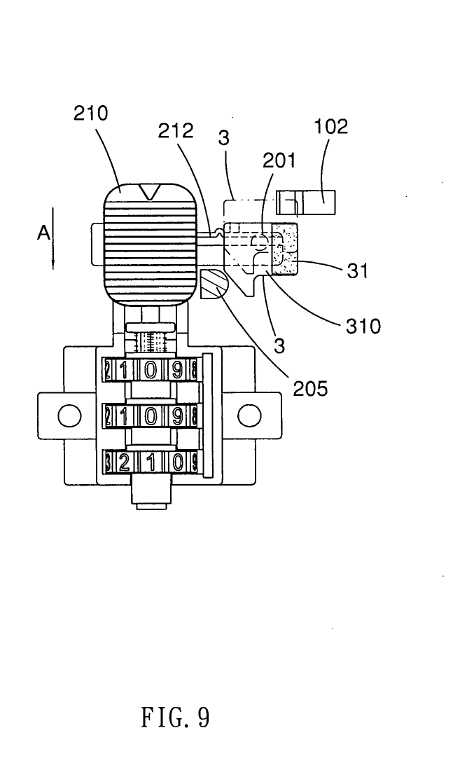

Referring to FIG. 9, the indicator 3 mounted on the guide lever 212 of the push button 210 is movable with the push button 210 in the direction indicated by the arrow “A”. At this time, the first side 321 of the second ramp 32 of the indicator 3 constantly faces and does not touch the guide block 205 of the second housing 20, so that the indicator 3 is not movable along the guide lever 212 of the push button 210. When the indicator 3 is movable with the push button 210 to the position as shown in FIG. 9, the indicator 3 leaves the push block 102, so that even when the indicator 3 is movable downward with the push button 210, the indicator 3 does not touch the push block 102. Thus, the indicator 3 is only movable with the push button 210 and is not movable along the guide lever 212 of the push button 210 when the double lock is disposed at the first unlocked state. It is to be noted that, the second identification zone 310 of the indicator 3 has a determined width, so that the peep hole 201 of the second housing 20 presents the green color when the indicator 3 is movable with the push button 210 in the direction indicated by the arrow “A” and when the indicator 3 is returned to the original position.

Referring to FIGS. 3-9, when the double lock is disposed at a locked state, the peep hole 201 of the second housing 20 presents the green color. In addition, when the number wheels 211a of the number wheel unit 211 are rotated to reach a correct code of the number wheel unit 211 and the double lock is disposed at a first unlocked state, the peep hole 201 of the second housing 20 presents the green color even when the indicator 3 is movable with the push button 210.

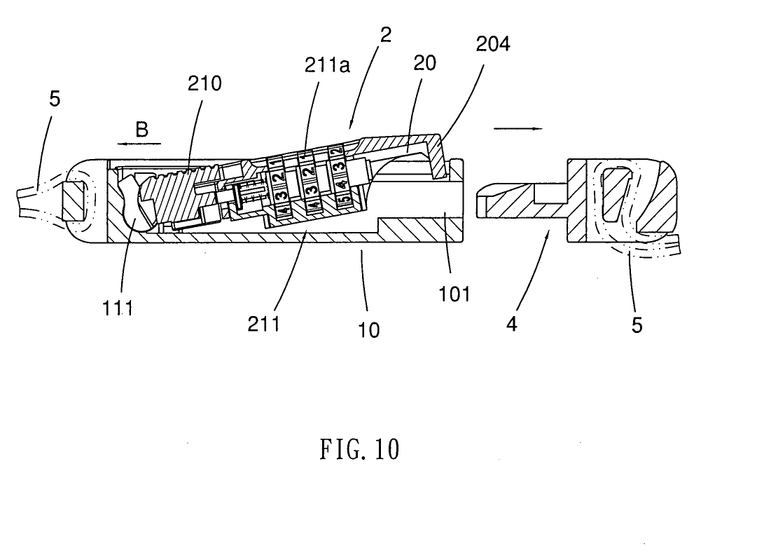

Referring to FIG. 10, the spindle 110a of the lock core 110 is rotated by the specific key so that the catch block 111 is driven to move in the direction indicated by the arrow “B”. At this time, although the number wheels 211a of the number wheel unit 211 are rotated to miss the correct code of the number wheel unit 211 so that the push button 210 cannot be driven to push the catch block 111, the catch block 111 is driven by rotating the specific key to release the push button 210, so that the push button 210 can be pressed downward to pivot the second housing 20 to move the locking block 204 upward to release the insert 4 from the locking block 204, thereby removing the insert 4 from the slot 101 of the first housing 10 as shown in FIG. 10. Thus, the second lock body 2 is released by the key lock mechanism 11, so that the double lock is disposed at a second unlocked state. When the double lock is disposed at the second unlocked state, the insert 4 is removed from the slot 101 of the first housing 10 to release the luggage binding strap 5. At this time, even though the number wheels 211a of the number wheel unit 211 are rotated to miss the correct code of the number wheel unit 211 so that the push button 210 cannot be driven to push the catch block 111, the insert 4 can still be removed to release the luggage binding strap 5.

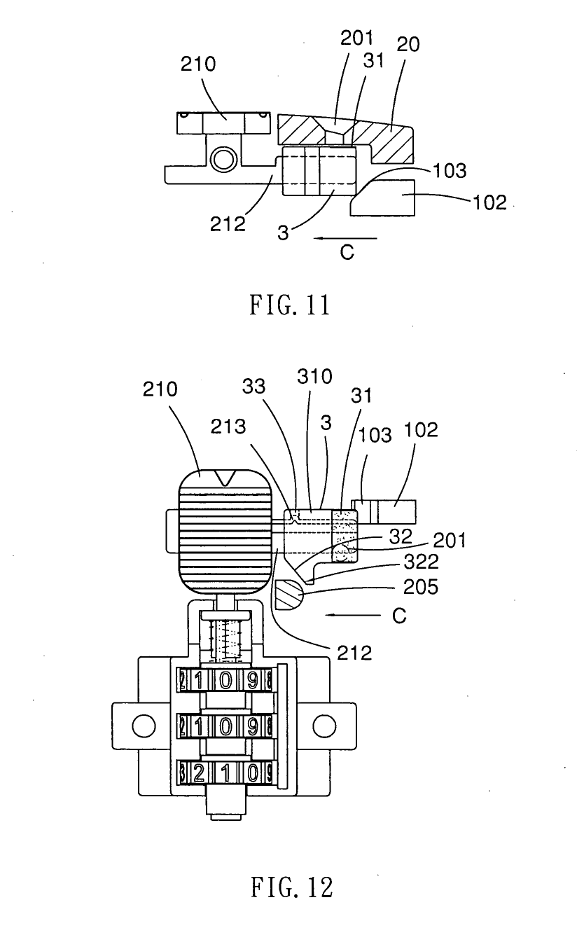

Referring to FIGS. 11 and 12, the double lock is disposed at the second unlocked state. At this time, the bottom face of the tail portion of the indicator 3 faces the first ramp 103 of the push block 102. Thus, when the indicator 3 is movable downward with the push button 210 to abut the first ramp 103 of the push block 102, the indicator 3 is pushed by the first ramp 103 of the push block 102 and is slidable on the guide lever 212 of the push button 210 in the direction indicated by the arrow “C”, so that the indicator 3 is movable to an indication position as shown in FIGS. 11 and 12. When the indicator 3 is movable on the guide lever 212 of the push button 210 to the indication position, the guide lever 212 of the push button 210 has an elastic boss 213 positioned in a positioning hole 33 of the indicator 3, so that the indicator 3 is positioned on the indication position temporarily. At this time, the second ramp 32 of the indicator 3 has a second side 322 facing the guide block 205 of the second housing 20, and the peep hole 201 of the second housing 20 is aligning with the first identification zone 31 of the indicator 3 to present the red color. When the force applied on the push button 210 is removed, the second housing 20 is pushed and returned to the original state by the restoring force of the second spring (not shown), and the push button 210 is returned to the original state. Then, the catch block 111 is driven by rotating the specific key to return to the original state so as to stop the push button 210. At this time, the peep hole 201 of the second housing 20 is still aligning with the first identification zone 31 of the indicator 3 to present the red color, which indicates that the double lock has been disposed at a second unlocked state.

When in use, the specific key is held by an inspector of the customs, and the double lock is disposed at the second unlocked state only when the spindle 110a of the lock core 110 is rotated by the specific key. Thus, when the double lock is disposed at the second unlocked state, the peep hole 201 of the second housing 20 presents the red color to remind the user that the double lock has been unlocked by the specific key held by the inspector of the customs.

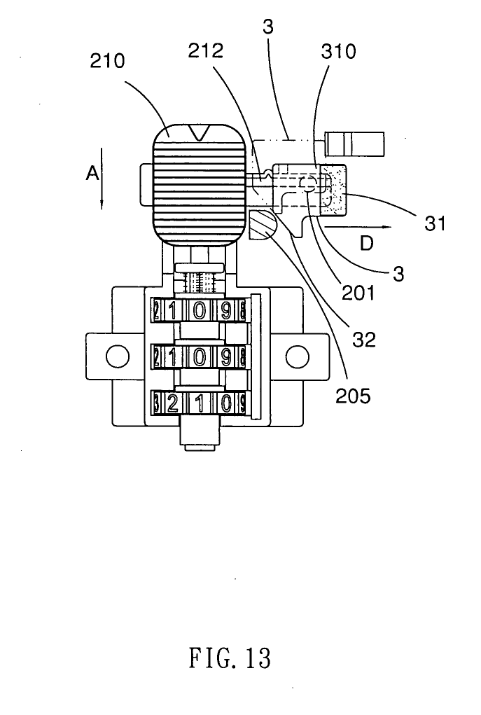

Referring to FIG. 13, after the double lock enters the second unlocked state, the number wheels 211a of the number wheel unit 211 are rotated to reach a correct code of the number wheel unit 211, so that the movable shaft 211b is movable axially, and the push button 210 is pushed in the direction indicated by the arrow “A” as shown in FIGS. 7 and 8. When the double lock enters the second unlocked state, the indicator 3 is movable to the indication position, the second side 322 of the second ramp 32 of the indicator 3 faces the guide block 205 of the second housing 20 as shown in FIG. 12. Thus, when the push button 210 is pushed in the direction indicated by the arrow “A” as shown in FIG. 13, the second ramp 32 of the indicator 3 is pushed by the guide block 205 of the second housing 20, so that the indicator 3 is movable on the guide lever 212 of the push button 210 in the direction indicated by the arrow “D” as shown in FIG. 13 to return to the original position until the peep hole 201 of the second housing 20 is aligning with the second identification zone 310 of the indicator 3 to present the green color. It is to be noted that, after the double lock enters the second unlocked state (that is, the second lock body 2 is released by the key lock mechanism 11), the indicator 3 is returned to the original position and the peep hole 201 of the second housing 20 presents the green color only when the double lock enters the first unlocked state (that is, the number wheels 211a of the number wheel unit 211 are rotated to reach a correct code of the number wheel unit 211).

In conclusion, when the double lock enters the second unlocked state (that is, the second lock body 2 is released by the key lock mechanism 11, and the number wheels 211a of the number wheel unit 211 are rotated to miss a correct code of the number wheel unit 211), the indicator 3 is driven by the second lock body 2 to the indication position, and when the double lock enters the first unlocked state (that is, the number wheels 211a of the number wheel unit 211 are rotated to reach a correct code of the number wheel unit 211), the indicator 3 is driven by the second lock body 2 to return to the original position. More specifically, when the number lock mechanism 21 misses the correct code, the indicator 3 is driven by the number lock mechanism 21 to the indication position, and when the number lock mechanism 21 reaches the correct code, the indicator 3 is driven by the number lock mechanism 21 to return to the original position.

Accordingly, the double lock has an indication function to remind the user if the double lock has been unlocked by the specific key held by an inspector of the customs for checking the luggage. In addition, the double lock has an indication function without having to provide a shackle that is used in the conventional padlock, thereby enhancing the versatility of the double lock.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A double lock, comprising:
a main body;
a strap connectable with the main body for binding a luggage;
a key lock mechanism mounted on the main body for locking the strap, which is releasable by a key;
a number lock mechanism mounted on the main body for locking the strap, which is releasable by a correct code;
an indicator mounted on the main body and movable to an indication position when the key lock mechanism is maneuvered.

2. The double lock in accordance with claim 1 wherein the main body includes:
a first lock body;
a second lock body movably mounted on the first lock body, the second lock body movable to a position where locks the strap and movable to another position where releases the strap,wherein movements of the second lock body are controlled by either one of the key lock mechanism and the number lock mechanism.

3. The double lock in accordance with claim 12, wherein the second lock body has a peep hole for presenting the indicator in the indication position.

4. The double lock in accordance with claim 3, wherein:
the number lock mechanism includes a push button movably mounted on the second lock body, and a number wheel unit including a plurality of number wheels and a movable shaft being in contact with the push button, thereby the movable shaft being movable by the push button, and wherein the number wheels are mounted on the second lock body for allowing the movable shaft to move axially so that the second lock body can be released from the first lock body when the number wheels are rotated to reach the correct code and preventing the movable shaft to move axially so that the second lock body is locked to the first lock body when the number wheels are rotated to miss the correct code.

5. The double lock in accordance with claim 14, wherein the indicator has a positioning hole, and the guide lever of the push button has an elastic boss which is positioned in the positioning hole of the indicator when the indicator is movable to the indication position.

6. The double lock in accordance to claim 2, wherein the indicator is returnable to an original position when the number lock mechanism is maneuvered.

7. The double lock in accordance to claim 2, wherein the key lock mechanism is mounted in one of the first and second lock bodies.

8. The double lock in accordance to claim 7, wherein the key lock mechanism is mounted in the first lock body.

9. The double lock in accordance to claim 2, wherein the number lock mechanism is mounted in one of the first and second lock bodies.

10. The double lock in accordance to claim 9, wherein the number lock mechanism is mounted in the second lock body and movable with the second lock body.

11. The double lock in accordance to claim 2, wherein the indicator is mounted in one of the first and second lock bodies.

12. The double lock in accordance to claim 11, wherein the indicator is mounted in the second lock body.

13. The double lock in accordance to claim 3, wherein the indicator comprises an identification zone observable through the peep hole when the indicator is in the indication position.

14. The double lock in accordance to claim 4, wherein:
the push button has a guide lever for movably supporting the indicator;
the first lock body has a push block which has a first ramp;
the second lock body has a guide block facing the peep hole; and
the indicator has a second ramp so that the indicator is moved to the indication position by the first ramp when the push button is moved in a direction, and the indicator is retuned to the original potion due to the second ramp sliding on the push block when the push button is moved in a transverse direction.
